(19) United States
(12) Patent Application Publication
(10) Pub. No.: US 2005/0152145 A1
(43) Pub. Date: Jul. 14, 2005

(54) Vehicle lighting system having an electronic module circuit and light emitting diodes

(76) Inventors: Robert M. Currie, Dollard-Des Ormeaux (CA); Eliot Sorella, Laval (CA)

Correspondence Address: MEREK, BLACKMON & VOORHEES, LLC, 673 South Washington Street, Alexandria, VA, 22314, US

(21) Appl. No.: 10/928,701

(22) Filed: Aug. 30, 2004

Related U.S. Application Data
(60) Provisional application No. 60/498,300, filed on Aug. 28, 2003.
(60) Provisional application No. 60/499,352, filed on Sep. 3, 2003.

(51) Int. Cl. B60L 1/00

(52) U.S. Cl. 362/294

(57) ABSTRACT

An electronic module circuit for operating a light emitting diode vehicle lighting system. The electronic module circuit includes an adaptor for regulating a 12 volt vehicle power supply to operate the light emitting diode vehicle lighting system. The light emitting diodes include dual light emitting diodes in a single optic have concave and convex depressions for collimating the emitted light.

### CLAIM FOR PRIORITY

This application claims priority from U.S. Provisional Patent Application Ser. No. 60/498300 filed Aug. 28, 2003 and U.S. Provisional Patent Application Ser. No. 60/499352 filed Sep. 3, 2003. Both of these provisional applications are incorporated herein by reference.

### FIELD OF THE INVENTION

This invention relates to vehicle lighting systems using light emitting diodes.

### BACKGROUND OF THE INVENTION

Electrical wiring for electrical accessories attached or linked to vehicles have different methods in connecting. One method of connection is simply locating desired wires of a vehicle electrical system and cutting, stripping and splicing. Another method simply connects an adaptor plug to the existing tail light plug or trailer hitch plug or other prefabricated connector located within the vehicle wiring system.

Most automotive lighting is designed to cooperate with the customary 12 volt power supply. Recently, light emitting diodes LEDs have been introduced to the automotive market which required a lower voltage than 12 volts for proper operation. Resistors, transformers, regulators, capacitors and/or other electrical components are necessary to lower the voltage to properly operate the LEDs.

Many such LEDs are manufactured as single unit. Today's LEDs have multiple colors also contained as a single unit. LEDs are also known to incorporate different optics which magnify and collimate the light transmission.

### OBJECTS AND SUMMARY OF THE INVENTION

It is an object of the invention to provide an electronic module circuit to facilitate the use of LEDs in a vehicle lighting system.

It is another object of the invention to provide an adapter for connection of the electronic module circuit directly to a vehicle accessory tail light plug or trailer hitch plug.

It is another object of the invention to provide an electronic module circuit for reducing the voltage of the vehicle power supply to properly operate an LED lighting system.

Yet another object of the invention is to provide an optic of an LED which incorporates two single LEDs mounted on a substrate with one optic.

These and other objects of the present invention will be readily apparent upon review of the following detailed description of the invention and the accompanying drawings. These objects of the present invention are not exhaustive and are not to be construed as limiting the scope of the claimed invention.

In summary, the invention involves an electronic module for the automotive industry. The electronic module includes electronic components to switch, regulate and control voltage and current at designed ratios. LED lighting accessories require regulated low voltage and current. The standard automotive 12 volt direct current system is exceedingly high for the conventional low voltage LED. The electronic components of the electronic module lower the standard 12 volt supply by transformer or the like and then manipulates the supply to different output channels. The output channels are extensions connected to the after market accessory LEDs mounted at designated positions on any type of vehicle. The LED aftermarket accessory lighting may operate with the vehicle lighting system or with a manually switched system. Preferably the electronic module incorporates wiring for the input and wiring with plugs for the output. Wires can be color coded to match the vehicle OEM electrical wiring system. The electronic module is able to interface with all automotive rear lighting systems and can be activated by the park or tail light voltage. The electronic module is preferably operable to flash with the directional system and activate with the brake light system. The electronic module is preferably is designed to operate with illuminated bed rails.

The LEDs preferably include an aluminum heat sink substrate preferably shaped to a predetermined radius to mount in a predesigned aluminum cavity. A non-conductive coating is applied to one side of the substrate having copper run landings. A barrel shaped plastic material is mounted at the radius area to harness and support an acrylic optic. The acrylic optic is mounted on top of a lumiled bat wing surface mount LED. The acrylic optic includes a two hole aperature at the bottom of the optic to receive the dome heads of the lumiled LEDs.

With these and other considerations in mind, as will become apparent hereinafter, the invention includes certain novel features of construction, combination and arrangement of parts and portions as will be set forth in the appended claims, reference being had to the accompanying drawings and detailed description thereof.

### BRIEF DESCRIPTION OF THE DRAWINGS

FIG. 1 shows a vehicle having a trailer hitch plug with the electronic module connected thereto;

FIG. 2 shows another embodiment of the electronic module having an accessory wiring adaptor connected thereto;

FIG. 3 is a schematic of the electronic module electronic circuit;

FIG. 4 is a top view of the dual LED with the optic removed; and,

FIG. 5 is a side view of the dual LED and single optic unit.

### DETAILED DESCRIPTION OF THE INVENTION

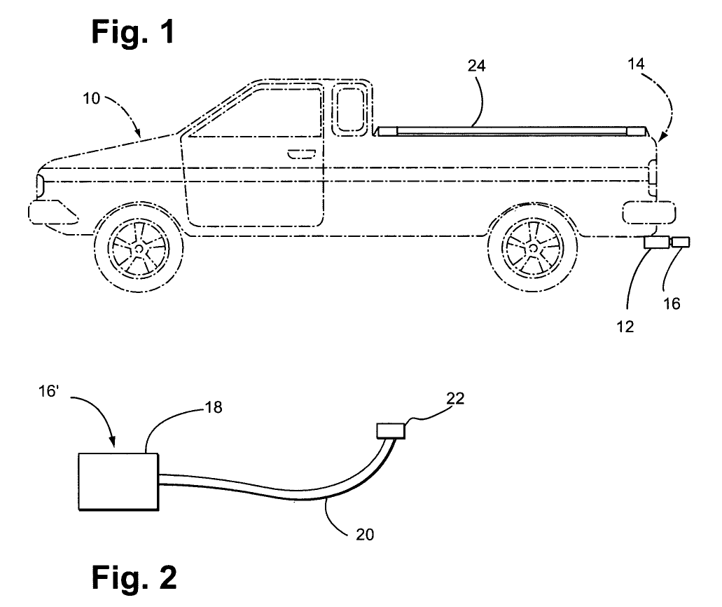

FIG. 1 show a vehicle 10, in this instance a pickup truck having a trailer hitch plug 12 at the rear 14 thereof. Trailer hitch plugs 12 usually have four or seven prong connections. Connected to the trailer hitch plug 12 is the electronic module 16 and the electronic module 16 preferably includes a suitable adapter to connect with conventional trailer hitch plugs 12 either of the four or seven prong variety. It should be understood that FIG. 1 is an example of merely one embodiment of the invention and that the electronic module circuit 16 may be hardwired into the vehicle wiring system or connected to a multiwire connector at some other location in the vehicle wiring system. However, it is contemplated by the invention that the trailer hitch plug 12 is commonly located on modem vehicles at the rear thereof and is therefore a convenient location for utilization of the invention. In other instances such as other auxiliary lighting schemes, different locations for connection may be preferably employed.

Now referring to FIG. 2, another embodiment of the electronic module 16′ is shown separately. The electronic module 16′ includes a circuit containing housing 18 having a pigtail wiring harness 20 extending therefrom and ending in a plug 22. The housing 18 preferably plugs into a trailer hitch plug 12 as previously described with reference to FIG. 1. Referring again to FIG. 1, the vehicle 10 is shown having lighted bed rails 24. The present invention is ideally suited for use with auxiliary lighting such as the lighted bed rails 24 such as those described in U.S. Pat. No. 5,495,400 which is hereby incorporated by reference. With either embodiment of the electronic module 16 or 16′, the bed rails 24 may be electronically connected to the electronic module 16 or 16′ simply by incorporating a cooperating connector (not shown) into the bed rails 24 which electronically connects directly to module 16 or connects to plug 22 of the wiring harness 20.

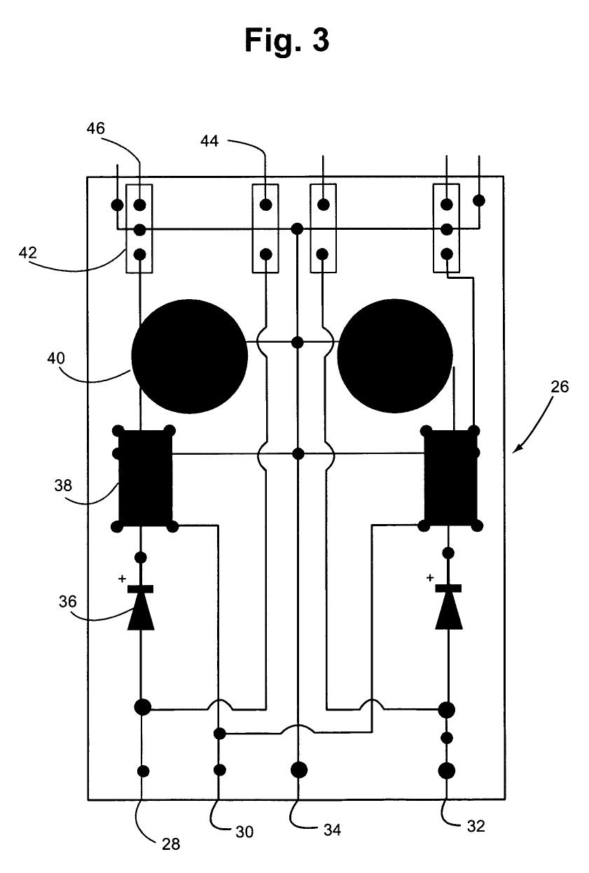

FIG. 3 is a schematic diagram for a preferred embodiment of the electronic circuit 26 of the electronic module 16. The circuit 26 includes inputs for the left brake/directional light input 28, parking lamp input 30 and right brake/directional light input 32. A common ground 34 is also included at the inputs. In a vehicle lighting system having lighted bed rails 24, illumination of the bed rails 24 is effected when the vehicle brake or directional signal is activated so that current flows to the electronic module 16 and enters the circuit 26. Now for example, when the left brake/directional input 28 is activated, current flows to diode 36 which preferably is a one amp 100plv diode then flows to preferably a 12vdc one amp reed relay 38 and then preferably flows to a 50 vdc capacitor 40 and then preferably flows to a 6 vdc regulator 42 and out to the bed rail 24. In this manner, the brake lamp output 44 will operate continuously while the directional signal output 46 will flash. The right brake/directional light input 32 operates in the same manner as the left. The parking lamp 30 input bypasses the diodes 36.

Using the above described electronic module 16, the automotive 12 volt direct current is regulated to preferably controlled 3.6 volts direct current. It should be understood that the configuation of the electronic module 16 to connect to conventional four or seven prong trailer hitch plug is known to those skilled in the art and therefore has been omitted. Likewise, the output end of the electronic module 16 is similarly not shown since a variety of commercially available conventional plugs may be incorporated to serve this purpose.

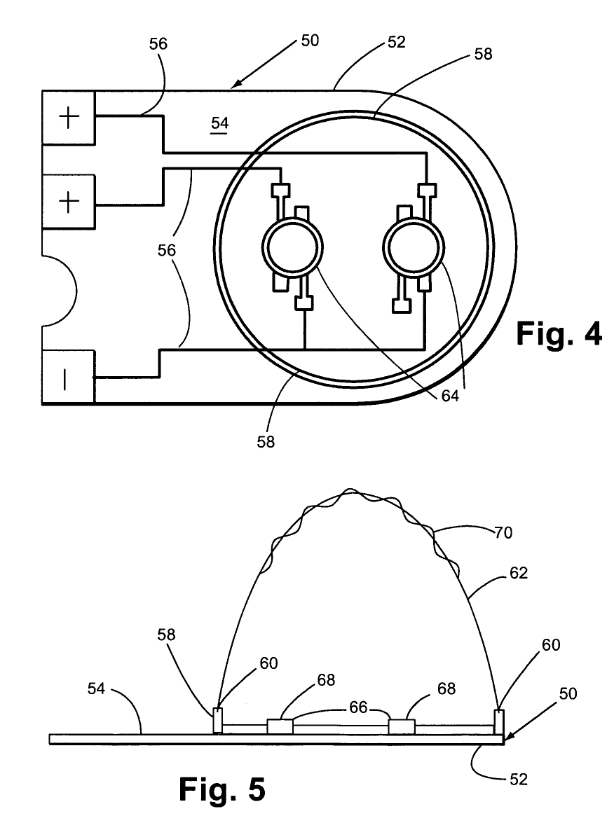

The above system may be used to light a unique LED optic to illuminate bed rails or other decorative and/or functional lighting. Now with reference to FIGS. 4 and 5, a dual LED single optic assembly 50 is shown having an aluminum heat sink substrate 52 of predetermined shape having a non-conductive coating 54 applied to one side thereof. The non-conductive coating 54 preferably has a thickness of about 25 thousandths of an inch and encompasses the complete surface area of one side of the substrate 52. Copper landings 56 having a thickness of about 12 thousandths of an inch are bonded to the non-conductive coating 54. A ring of plastic material 58 forms a cylinder or barrel on the substrate 52 and is mounted to the substrate 52 preferably by glue. The ring 58 includes slots 60 for providing connection to the acrylic optic 62. A pair of preferably surface mount LUMILED® bat wing LEDs 64 are mounted on the substrate 52 within the ring 58 and are preferably by soldering to the copper landings 56 on the non-conductive coating 54. The acrylic optic 62 incorporates a two hole aperature 66 for receiving the epoxy dome heads 68 of the lumiled LEDs 64.

The optic 62 preferably includes concave and convex impressions 70 and depressions to facilitate collimating illumination effects.

While this invention has been described as having a preferred design, it is understood that it is capable of further modifications, uses and/or adaptations of the invention following in general the principle of the invention and including such departures from the present disclosure as come within the known or customary practice in the art to which the present invention pertains and as maybe applied to the central features hereinbefore set forth, and fall within the scope of the invention and the limits of the appended claims.

1. A lighting system for a vehicle comprising:
a) a vehicle having a power source for a lighting system including light emitting diodes;
b) connector components for enabling electronic interface between said power source and said lighting system;
c) said connector components having an electronic circuit for regulating and reducing voltage from said power source to said lighting system;
d) said electronic circuit regulates voltage from said power source so that voltage output from said circuit is calibrated to operate said light emitting diodes of said lighting system.

2. The lighting system as set forth in claim 1, wherein;
a) said connector components include plug adaptors to physically connect said lighting system to said vehicle power source.

3. The lighting system as set forth in claim 1, wherein;
a) said vehicle includes a trailer hitch plug and said connector components include plug adaptors to physically connect said lighting system to said trailer hitch plug.

4. The lighting system as set forth in claim 1, wherein;
a) said power source provides 12 volt direct current to said lighting system and said connector components include voltage regulators to reduce said 12 volt direct current to 3.6 volts direct current.

5. The lighting system as set forth in claim 1, wherein;
a) said connector components are directly wired to said vehicle power source.

6. The lighting system as set forth in claim 1, wherein;
a) said electronic circuit activates said light emitting diodes to operate with said vehicle power source to selectively flash with a vehicle directional system.

7. The lighting system as set forth in claim 1, wherein;
a) said electronic circuit activates said light emitting diodes to operate with said vehicle power source to selectively flash with a vehicle brake light system.

8. The lighting system as set forth in claim 1, wherein;
a) said light emitting diodes each include a dual light emitting diode having a single optic.

9. The lighting system as set forth in claim 8, wherein;
a) said optic includes concave and convex impressions and depressions.

10. An auxiliary lighting system for a vehicle comprising:
a) a vehicle having a power source for a providing power to an auxiliary lighting system including light emitting diodes;
b) said auxiliary lighting system including connector components for enabling electronic interface between said power source and said auxiliary lighting system;
c) said connector components having an electronic circuit for regulating and reducing voltage from said power source;
d) said electronic circuit regulates voltage from said power source so that voltage output from said circuit is calibrated to operate said light emitting diodes of said auxiliary lighting system.

11. The auxiliary lighting system as set forth in claim 10, wherein;
a. said connector components include plug adaptors to physically connect said auxiliary lighting system to said vehicle power source.

12. The auxiliary lighting system as set forth in claim 10, wherein;
a) said vehicle includes a trailer hitch plug and said connector components include plug adaptors to physically connect said auxiliary lighting system to said trailer hitch plug.

13. The auxiliary lighting system as set forth in claim 10, wherein;
a) said power source provides 12 volt direct current to said auxiliary lighting system and said connector components include voltage regulators to reduce said 12 volt direct current to 3.6 volts direct current.

14. The auxiliary lighting system as set forth in claim 10, wherein;
a) said connector components are directly wired to said vehicle power source.

15. The lighting system as set forth in claim 10, wherein;
a) said electronic circuit activates said light emitting diodes to operate with said vehicle power source to selectively flash with a vehicle directional system.

16. The lighting system as set forth in claim 10, wherein;
a) said electronic circuit activates said light emitting diodes to operate with said vehicle power source to selectively flash with a vehicle brake light system.

17. The lighting system as set forth in claim 10, wherein;
a) said light emitting diodes each include a dual light emitting diode having a single optic.

18. The lighting system as set forth in claim 16, wherein;
a) said optic includes concave and convex impressions and depressions.

19. A light emitting diode construction comprising:
a) An acrylic optic having two or more concave and convex impressions for focusing and collimating illumination from two or more light emitting diodes.

20. The light emitting diode construction as set forth in claim 19 further comprising:
a) an aluminum heat sink substrate with non-conductive coating and copper landings designed for two or more different color light emitting diodes.
